(19) United States
(12) Patent Application Publication
(10) Pub. No.: US 2014/0136859 A1
(43) Pub. Date: May 15, 2014

(54) HUMIDITY MEASURING CIRCUIT

(71) Applicants: HONG FU JIN PRECISION INDUSTRY (SHENZHE, Shenzhen (CN); HON HAI PRECISION INDUSTRY CO., LTD., New Taipei (TW)

(72) Inventor: WEN-PING YANG, Shenzhen (CN)

(73) Assignees: HON HAI PRECISION INDUSTRY CO.,LTD., New Taipei (TW); HONG FU JIN PRECISION INDUSTRY (ShenZhen) CO.,LTD., Shenzhen (CN)

(21) Appl. No.: 13/688,262

(22) Filed: Nov. 29, 2012

(30) Foreign Application Priority Data
Nov. 15, 2012 (CN) 2012104594457

(51) Int. Cl. G06F 1/26

(52) U.S. Cl. CPC G06F 1/26
USPC 713/300

(57) ABSTRACT

A humidity measuring circuit includes a comparing circuit and a switch circuit. The comparing circuit measures humidity and compares the measured humidity with a preset value, to output a first control signal or a second control signal. The switch circuit receives the first or second control signal and controls a computer to be powered on or not. When humidity measured by the comparing circuit is greater than the preset value, the comparing circuit outputs the first control signal to the switch circuit. The switch circuit is turned on and controls the computer not to be powered on. When humidity measured by the comparing circuit is equal to or less than the preset value, the comparing circuit outputs the second control signal to the switch circuit. The switch circuit is turned off and controls the computer to be powered on.

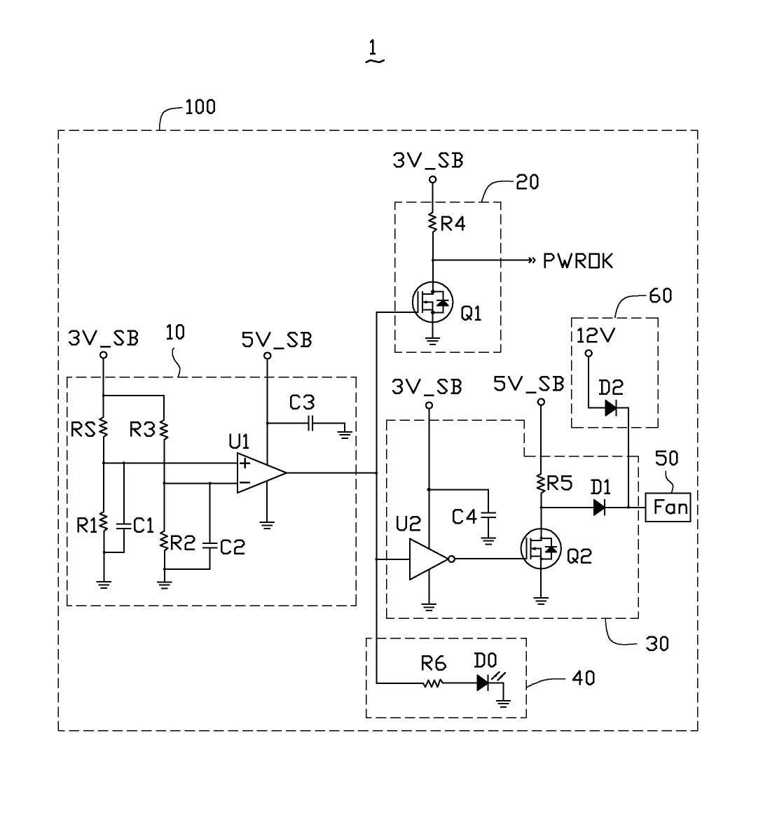

### BACKGROUND

1. Technical Field

The present disclosure relates to measuring circuits, and particularly to a measuring circuit for measuring humidity inside a computer.

2. Description of Related Art

Performance of components on a motherboard of a computer may be affected by ambient humidity changes, this may cause the computer to malfunction or be damaged when powering on. Therefore, there is room for improvement in the art.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The FIGURE is a circuit diagram of a humidity measuring circuit in accordance with an exemplary embodiment of the present disclosure.

### DETAILED DESCRIPTION

The disclosure, including the drawing, is illustrated by way of example and not by way of limitation. References to “an” or “one” embodiment in this disclosure are not necessarily to the same embodiment, and such references mean at least one.

The FIGURE shows a humidity measuring circuit 100 of the embodiment. The humidity measuring circuit 100 is arranged on a motherboard of a computer 1. The humidity measuring circuit 100 includes a comparing circuit 10, a first switch circuit 20, a second switch circuit 30, an indication circuit 40, a fan 50, and a power supply circuit 60. The comparing circuit 10 measures humidity inside the computer 1 and outputs a first or a second control signal to the first and second switch circuits 20 and 30 and the indication circuit 40 according to the measured humidity. The first switch circuit 20 receives the first or second control signal and controls the computer 1 to be powered on or not according to the first or second control signal. The second switch circuit 30 receives the first or second control signal and controls the fan 50 to turn on and dissipate moisture or dissipate heat. The indication circuit 40 displays the humidity inside the computer 1.

When the humidity measured by the comparing circuit 10 is greater than a preset value, the comparing circuit 10 outputs a first control signal to the first switch circuit 20 and the second switch circuit 30. The first switch circuit 20 is turned on and controls the computer 1 not to be powered on. The second switch circuit 30 is turned off and controls the fan 50 to receive a voltage through the second switch circuit 30 for dissipating moisture. The indication circuit 40 displays a result about the measured humidity being greater than the preset value. When the humidity measured by the comparing circuit 10 is equal to or less than the preset value, the comparing circuit 10 outputs a second control signal to the first switch circuit 20 and the second switch circuit 30. The first switch circuit 20 is turned off and controls the computer 1 to be powered on. The second switch circuit 30 is turned on and controls the fan 50 to receive a voltage from the power supply circuit 60 for dissipating heat. The indication circuit 40 displays a result about the measured humidity being equal to or less than the preset value.

The comparing circuit 10 includes a hygristor RS, resistors R1-R3, capacitors C1-C3, and a comparator U1. A non-inverting input terminal of the comparator U1 is connected to a power source 3V_SB through the hygristor RS and also grounded through the resistor R1. An inverting input terminal of the comparator U1 is connected to the power source 3V_SB through the resistor R3 and also grounded through the resistor R2. A voltage terminal of the comparator U1 is connected to a power source 5V_SB. An output terminal of the comparator U1 is connected to the first and second switch circuits 20 and 30 and the indication circuit 40. The capacitor C1 is connected between the non-inverting input terminal of the comparator U1 and ground. The capacitor C2 is connected between the inverting input terminal of the comparator U1 and ground. The capacitor C3 is connected between the voltage terminal of the comparator U1 and ground. The preset value can be changed by changing resistances of the resistors R2 and R3.

The first switch circuit 20 includes an electronic switch, such as an n-channel field effect transistor (FET) Q1, and a resistor R4. A gate of the FET Q1 is connected to the output terminal of the comparator U1. A drain of the FET Q1 is connected to a power-on signal terminal PWROK of the computer 1 and also connected to the power source 3V_SB through the resistor R4. A source of the FET Q1 is grounded. In one embodiment, the hygristor RS is a negative coefficient hygristor. Namely, the resistance of the hygristor RS decreases when the surrounding humidity increases, and the resistance of the hygristor RS increases when the surrounding humidity decreases.

The second switch circuit 30 includes an inverter U2, an electronic switch, such as an n-channel FET Q2, a resistor R5, a capacitor C4, and a diode D1. An input terminal of the inverter U2 is connected to the output terminal of the comparator U1. A voltage terminal of the inverter U2 is connected to the power source 3V_SB. An output terminal of the inverter U2 is connected to a gate of the FET Q2. A drain of the FET Q2 is connected to an anode of the diode D1 and also connected to the power source 5V_SB through the resistor R5. A source of the FET Q2 is grounded. A cathode of the diode D1 is connected to the fan 50. The capacitor C4 is connected between the voltage terminal of the inverter U2 and ground.

The power supply circuit 60 includes a power source 12V and a diode D2. An anode of the diode D2 is connected to the power source 12V. A cathode of the diode D2 is connected to the fan 50.

The indication circuit 40 includes a resistor R6 and a light emitting diode (LED) D0. An anode of the LED D0 is connected to the output terminal of the comparator U1 through the resistor R6. A cathode of the LED D0 is grounded.

In use, when the computer 1 is suspended or off, and heat is not generated by components inside the enclosure, humidity inside the computer 1 may increase, the resistance of the hygristor RS decreases. When humidity inside the computer 1 is greater than the preset value, the voltage of the non-inverting input terminal of the comparator U1 is greater than the preset value of the inverting input terminal of the comparator U1. The comparator U1 outputs a high level signal. The FET Q1 is turned on. The drain of the FET Q1 outputs a low level signal to the power-on signal terminal PWROK of the computer 1 to control the computer 1 not to be powered on. The inverter U2 receives the high level signal from the output terminal of the comparator U1 and outputs a low level signal. The FET Q2 is turned off. Due to the computer 1 not being powered on, the power source 12V does not output a voltage. The fan 50 receives a voltage from the power source 5V_SB through the diode D1 for dissipating moisture. The LED D0 receives the high level signal from the output terminal of the comparator U1 and emits light, to display that the humidity inside the computer 1 is greater than the preset value.

When humidity inside the computer 1 decreases, the resistance of the hygristor RS increases. When humidity inside the computer 1 is equal to or less than the preset value, the voltage of the non-inverting input terminal of the comparator U1 is less than the preset voltage of the inverting input terminal of the comparator U1. The comparator U1 outputs a low level signal. The FET Q1 is turned off. The power-on signal terminal PWROK of the computer 1 receives a high level signal from the power source 3V_SB and controls the computer 1 to be powered on. The inverter U2 receives the low level signal from the output terminal of the comparator U1 and outputs a high level signal. The FET Q2 is turned on. The fan 50 does not receive a voltage from the power source 5V_SB. Due to the computer 1 being powered on, the power source 12V outputs a voltage. The fan 50 receives a voltage from the power source 12V through the diode D2 for dissipating heat. The LED D0 receives the low level signal from the output terminal of the comparator U1 and does not emit light, to display that the humidity inside the computer 1 is equal to or less than the preset value.

The humidity measuring circuit 100 measures humidity inside the computer 1 by the comparing circuit 10 and outputs the first or second control signal according to the measured humidity. The first switch circuit 20 is turned on or turned off for controlling the computer 1 to be powered on or not according to the first or second control signal. The second switch circuit 30 is turned off or turned on for controlling the fan 50 to receive a voltage from the second switch circuit 30 for dissipating moisture or receive a voltage from the power supply circuit 60 for dissipating heat. The indication circuit 40 displays the humidity inside the computer 1. The humidity measuring circuit 100 can measure humidity inside the computer 1, to prevent the computer 1 from being damaged.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A humidity measuring circuit, comprising:
a comparing circuit to measure humidity and compare the measured humidity with a preset value, to output a first control signal or a second control signal according to a measured result; and
a first switch circuit connected to the comparing circuit, to receive the first control signal or the second control signal, and control a computer to be powered on or not;
wherein when humidity measured by the comparing circuit is greater than the preset value, the comparing circuit outputs the first control signal to the first switch circuit, the first switch circuit is turned on and controls the computer not to be powered on; when humidity measured by the comparing circuit is equal to or less than the preset value, the comparing circuit outputs the second control signal to the first switch circuit, the first switch circuit is turned off and controls the computer to be powered on.

2. The humidity measuring circuit of claim 1, further comprising a second switch circuit, a power supply circuit, and a fan connected to the second switch circuit and the power supply circuit, wherein the second switch circuit receives the first control signal from the comparing circuit and is turned off to control the fan to receive a voltage through the second switch circuit for dissipating moisture; the second switch circuit receives the second control signal from the comparing circuit and is turned on, to control the fan to receive a voltage from the power supply circuit for dissipating heat.

3. The humidity measuring circuit of claim 2, wherein the comparing circuit comprises a hygristor, first to third resistors, and a comparator, a non-inverting input terminal of the comparator is connected to a first power source through the hygristor and also grounded through the first resistor, an inverting input terminal of the comparator is connected to the first power source through the third resistor and also grounded through the second resistor, a voltage terminal of the comparator is connected to a second power source, an output terminal of the comparator is connected to the first and second switch circuits.

4. The humidity measuring circuit of claim 3, wherein the comparing circuit further comprises first to third capacitors, the first capacitor is connected between the non-inverting input terminal of the comparator and ground, the second capacitor is connected between the inverting input terminal of the comparator and ground, the third capacitor is connected between the voltage terminal of the comparator and ground.

5. The humidity measuring circuit of claim 3, further comprising an indication circuit connected to the comparing circuit, wherein the indication circuit receives the first control signal from the comparing circuit for displaying that the measured humidity is greater than the preset value; the indication circuit receives the second control signal from the comparing circuit for displaying that the measured humidity is equal to or less than the preset value, wherein the indication circuit comprises a fourth resistor and a light emitting diode (LED), an anode of the LED is connected to the output terminal of the comparator through the fourth resistor, a cathode of the LED is grounded.

6. The humidity measuring circuit of claim 3, wherein the first switch circuit comprises an electronic switch and a fourth resistor, a first terminal of the electronic switch is connected to the output terminal of the comparator, a second terminal of the first electronic switch is connected to a power-on signal terminal of the computer and also connected to the first power source through the fourth resistor, a third terminal of the first electronic switch is grounded.

7. The humidity measuring circuit of claim 6, wherein the electronic switch is an n-channel field effect transistor (FET), the first to third terminals of the electronic switch correspond to a gate, a drain, and a source of the FET.

8. The humidity measuring circuit of claim 3, wherein the second switch circuit comprises an inverter, an electronic switch, a fourth resistor, and a first diode, an input terminal of the inverter is connected to the output terminal of the comparator, a voltage terminal of the inverter is connected to the first power source, an output terminal of the inverter is connected to a first terminal of the electronic switch, a second terminal of the switch is connected to an anode of the first diode and also connected to the second power source through the fourth resistor, a third terminal of the electronic switch is grounded, a cathode of the first diode is connected to the fan.

9. The humidity measuring circuit of claim 8, wherein the electronic switch is an n-channel field effect transistor (FET), the first to third terminals of the electronic switch correspond to a gate, a drain, and a source of the FET.

10. The humidity measuring circuit of claim 8, wherein the power supply circuit comprises a third power source and a second diode, an anode of the second diode is connected to the third power source, a cathode of the second diode is connected to the fan.
